(19) United States
(12) Patent Application Publication
(10) Pub. No.: US 2024/0307850 A1
(43) Pub. Date: Sep. 19, 2024

(54) Method for Producing a Multi-Capillary Lining

(71) Applicant: SEPARATIVE, Saint-Frons (FR)

(72) Inventor: François Parmentier, St Martin D'Heres (FR)

(21) Appl. No.: 18/576,611

(22) PCT Filed: Jul. 5, 2022
(86) PCT No.: PCT/FR2022/051345

§ 371 Date: Jan. 4, 2024

(30) Foreign Application Priority Data
Jul. 5, 2021 (FR) FR2107256

(51) Int. Cl. B01J 20/28; B01J 20/10; B01J 20/16; B01J 20/20; B01J 20/26; B01J 20/283; B01J 20/30; B01J 20/32

(52) U.S. Cl. CPC B01J 20/28045; B01J 20/103; B01J 20/165; B01J 20/20; B01J 20/262; B01J 20/28023; B01J 20/283; B01J 20/305; B01J 20/3078; B01J 20/3238; B01J 20/3268; B01J 20/3289; B01J 20/28007; B01J 2220/82

(57) ABSTRACT

The invention relates to a method for producing a multi-capillary lining comprising a plurality of channels suitable for convection of a fluid between an inlet face and an outlet face of said lining, said method comprising the steps of: —providing at least one preform (1) suitable for forming, after ablation, a capillary channel (3) of the lining; —assembling said preforms into a bundle; —coating each preform (1) with a plurality of porous layers (2) by depositing alternating layers of a polyelectrolyte and nanoparticles or colloidal nanoparticles or by depositing alternating layers of said nanoparticles and a polymer glue; —bonding the coated preforms to form a porous monolith; and—ablating the preforms to form the channels in said porous monolith.

### FIELD OF THE INVENTION

The invention relates to a method for producing a multi-capillary packing suitable for forming a chromatography column.

### BACKGROUND OF THE INVENTION

Chromatography involves the passage of a fluid through a column comprising a stationary phase suitable for selectively retaining species contained in the fluid.

Chromatographic materials have been proposed based on bundles of capillary tubes having, on their wall, thicknesses of liquid chromatographic material or porous solid stationary phase.

Monolithic multi-capillary materials have also been proposed, passed through by open and contiguous channels, optionally porous monolithic materials.

These devices are difficult to produce due to the fineness of the channels required for certain applications.

They are also not very efficient, due to the variable thickness of the stationary phase deposited on their wall.

### BRIEF DESCRIPTION OF THE INVENTION

An object of the invention is to provide a method for producing a multi-capillary packing which has an improved efficiency for chromatography.

To this effect, the invention proposes a method for producing a multi-capillary packing comprising a plurality of channels suitable for convection of a fluid between an inlet face and an outlet face of said packing, said method comprising the steps of:
providing at least one preform suitable for forming, after ablation, a capillary channel of the packing;
assembling said preforms into a bundle;
coating each preform with a plurality of porous layers by depositing alternating layers of a polyelectrolyte and nanoparticles or colloidal nanoparticles, or by depositing alternating layers of said nanoparticles and a polymer glue,
bonding the coated preforms to form a porous monolith; and
ablating the preforms to form the channels in said porous monolith.

Preferably, at least one dimension from the length, width, thickness or diameter of the nanoparticles is less than 1 μm.

In some embodiments, the polyelectrolyte is chosen from polydiallylmethylammonium chloride, poly(diethylaminoethyl methacrylate) acetate, poly-8-methacrylyloxyethyldiethylmethyl ammonium methyl sulfate (poly-g-MEMAMS), or polymethacrylic acid.

The nanoparticles advantageously comprise a silica sol, an activated alumina sol, or an aluminosilicate, such as a zeolite.

In some embodiments, the bonding of the coated preforms is produced by sintering.

In some embodiments, the bonding of the coated preforms is produced by adding a binder between said preforms.

Said binder can be obtained by a sol gel method or by drying a sol.

In some embodiments, said binder comprises a silica gel.

In a particularly advantageous manner, the ablation of the preforms comprises at least one of following techniques: dissolving, chemical reaction, oxidation, pyrolysis, hydrolysis, vaporisation, depolymerisation.

The preforms have a diameter or, when the preforms have a non-circular cross-section, the diameter of a preform of circular cross-section having an identical area, less than 10 μm, preferably less than 5 μm.

In some embodiments, the preforms comprise polyamide fibres.

In other embodiments, the preforms comprise carbon fibres.

In a particularly advantageous manner, the nanoparticles or colloidal nanoparticles have at least one dimension of width, length, thickness or diameter, which is less than 0.2 μm.

In some embodiments, the nanoparticles or colloidal nanoparticles are porous.

In a particular advantageous manner, the polyelectrolyte or the polymer glue has a molecular weight suitable for preventing the penetration of said polyelectrolyte or said glue into the pores of said nanoparticles.

### BRIEF DESCRIPTION OF THE FIGURES

FIG. 1 shows a sectional view of a synthesis intermediate of the multi-capillary packing according to the invention.

FIG. 2 shows a synthesis intermediate of the multi-capillary packing according to the invention.

### DETAILED DESCRIPTION OF THE INVENTION

The invention relates to the formation of a multi-capillary packing comprising, firstly, the production of a monolith surrounding preforms suitable for forming, after ablation, a capillary channel of the packing, and, secondly, the ablation of the preforms in order to release each respective channel within the monolith.

The monolith is formed by coating each preform with a plurality of porous layers. As described in detail below, this coating can be produced by a so-called “layer-by-layer” method or by alternately depositing layers of nanoparticles and a polymer glue so as to form a film around each preform.

This layer-by-layer deposition makes it possible, in particular, to precisely control the thickness of the final layer.

Fine particles, such as nanoparticles, are preferably used. In the present text, nanoparticles are defined as being particles which have at least one of their dimensions (width, height, length or diameter) less than 1 μm, preferably less than 0.2 μm.

According to the invention, the dimensions of the nanoparticles are measured by scanning electron microscopy.

The use of a polyelectrolyte in the form of glue enables an additional advantage: it makes it possible to work on bundles of preforms such as fibres, and to simultaneously cover all the preforms of the bundle with a layer of a substance uniformly deposited by adsorption, chimisorption or physisorption over the entirety of the preforms, by submerging them in a bath in which this substance is to be found in solution. In this way, it is possible to treat a large number of fibres simultaneously by immersing the entire bundle, and therefore to treat advantageously and in particular, very fine fibres which it would be difficult and not very productive to handle and treat individually. Moreover, it is possible, using this technique, to assemble materials which do not have an affinity to one another, such as silica colloids on polymer fibres or carbon fibres.

Thus, a first layer of polyelectrolyte will be easily absorbed on a preform, in the form of a monolayer and, by subsequent treatment in another bath, nanoparticles or colloidal nanoparticles will be absorbed uniformly on this prelayer of polyelectrolyte, with which they have affinity, in the form of a monolayer of colloidal particles or nanoparticles uniformly agglutinated on the preform in such a way as to cover it. It is thus possible to deposit very fine layers on a plurality of fibres simultaneously, uniformly, totally and precisely at all points of the bundle. This operation can be repeated so as to stack, “layer-by-layer”, a deposit of increasing thickness, by alternating the layers of polyelectrolyte, which serve as glue between the layers, which is absorbed again, but this time on the deposited nanoparticles or colloidal particles, and deposits of colloids or nanoparticles which again agglutinate there. These operations are easily carried out by successively and repeatedly making contact with liquids alternately containing the polyelectrolyte and the nanoparticles or colloidal particles.

According to the invention, the nanoparticles are advantageously porous. Their porosity (or void fraction) is advantageously greater than 10% by volume, preferably greater than 20% by volume, still more preferably greater than 40% by volume.

The pore size of these nanoparticles is advantageously less than 200 nanometres and preferably less than 70 nanometres.

The nanoparticles are advantageously made of silica gel, activated alumina or an aluminosilicate.

The nanoparticles advantageously consist of a zeolite.

The polyelectrolyte acting as bonding agent advantageously has a molecular weight or molecular volume such that it is rejected by the pores and cannot penetrate them.

Similarly, in the case of use of a polymer glue, said polymer glue acting as bonding agent has a molecular weight or a molecular volume such that it is rejected by the pores and cannot penetrate them.

### Preforms

The preforms are threads or fibres, the outer shape of which defines the shape of the channel resulting from the ablation of the corresponding thread or fibre.

The preforms can typically have a circular cross-section; however, the use of preforms having a non-circular cross-section is not excluded.

In the remainder of the text, the term “diameter” will be used to designate the dimension of the cross-section of the preforms. In the case of non-circular preforms, the “diameter” should be understood as being the diameter of a preform of circular cross-section having an identical area.

The diameter of the preforms, which is equal to the inner diameter of the channels after ablation of the preforms, is chosen according to the desired diameter for the channels.

The preforms advantageously have a diameter less than 10 μm, and more advantageously less than 5 μm.

In some embodiments, the preforms are microfibres of diameter less than 0.5 μm. Such fibres can be made of a polymer material.

When the preforms have a sufficiently large diameter (for example greater than 1 μm), the ablation of the preforms generally leads to channels extending continuously over the entire length of the packing. When the preforms have a smaller diameter (for example less than 0.5 μm), it is possible that the channels created by ablation of said microfibres only extend over a fraction of the total length of the packing. However, such an interruption of the channels is not penalising for the performance of the packing, provided the monolithic material surrounding the channels is porous and can ensure the convection of fluid along the packing.

The preforms are preferably formed in material having good regularity of the diameter over their entire length, as well as good dimensional stability, in other words a capacity to not deform or change diameter during the production method of the packing.

The preforms are preferably made of a non-porous material.

In some embodiments, the preforms are polyamide threads.

On the other hand, according to a preferred embodiment of a multi-capillary monolith by ablation of preforms, the preforms are carbon fibres. Indeed, carbon fibres have many advantages:
1. They have the particular property of having excellent dimensional stability between their cold implementation and their hot behaviour. They do not give rise to any shrinkage, and the stability of the material is better ensured.
2. Their pyrolysis is not accompanied by any release of tars or toxic organic molecules, and leaves no ash.
3. Their very low coefficient of thermal expansion ensures excellent compatibility with a ceramic matrix coating them.
4. Their pyrolysis is produced under an atmosphere of air and produces only gaseous reaction products, carbon monoxide and carbon dioxide.
5. They are commercially available in the form of very small diameter fibres, from 10 μm to 4 μm or less, at very low cost, thus enabling efficient packings to be produced.

Therefore, preforms based on carbon fibres are advantageously used to carry out the method according to the invention.

Other materials are possible for the preforms, in particular threads made of polyester, polysulfone, polyglycolic acid, polydioxanone, poly(methyl methacrylate), polyamides, polyolefins, polyimides etc.

### Coating Preforms

Each preform is coated with a plurality of porous layers.
Various coating methods can be used. These methods can be applied on a batch of preforms which are then assembled into a bundle, or on an already formed preform bundle. The term “bundle” shall mean the assembly of preforms suitable for obtaining the desired channels.

Advantageously, the ablative preforms have dimensions that are as uniform as possible. The preforms can be characterised by at least two dimensions:
the diameter or hydraulic diameter of the preforms; and
the length of the preforms.

Advantageously, the diameter or hydraulic diameter has a variability characterised by its relative standard deviation of less than 30%, preferably less than 10%, yet more preferably less than 2% of the average diameter of the preforms.

In a first embodiment, the coating is produced by a so-called “layer-by-layer” method.

Such a method is known for the production of so-called “core-shell” products which are spherical particles of small diameter (2 to 3 μm), consisting of a dense core surrounded by a silica gel film. These particles are obtained by depositing a layer of gel on the core which is non-porous.

According to such a “layer-by-layer” method, the surfaces to be covered are exposed to alternating layers of binder and small size particles. This approach uses the electrostatic interactions (and also Van der Waals forces, hydrogen bonds, covalent bonds, etc.) between positively charged (cationic) species and negatively charged (anionic) species, in order to deposit multiple successive layers of material on a substrate.

A description of this technique can be found in the following reference [1], as well as in the patent [2].

In the present invention, a batch of preforms is subjected to the successive action of solutions of polyelectrolyte and negatively charged silica sols, activated alumina sols (boehmite), or aluminosilicates (for example zeolites).

The polyelectrolyte can, for example, be a polydiallylmethylammonium chloride, poly(diethylaminoethyl methacrylate) acetate, poly-8-methacrylyloxyethyldiethylmethyl ammonium methyl sulfate (poly-g-MEMAMS or polymethacrylic acid.

The silica or alumina sols, or the aluminosilicates can preferably consist of particles of diameter between 4 and 100 nm.

The cationic polyelectrolyte in solution is placed in contact with the preforms, deposited on each preform, and its excess is drained and washed. The preforms are then placed, covered in this way with an absorbed layer of polyelectrolyte, in aqueous solution with the silica sol (or alumina or aluminosilicate), which is itself absorbed on the polyelectrolyte. This operation is repeated as often as necessary until the desired thickness of layer is obtained around each preform. Said thickness is typically between 20 and 10,000 nm.

The preforms are dried, then pyrolysed and sintered in order to ensure removal of the organic compounds, the release of the pores and the mechanical cohesion of the assembly.

In a second embodiment, the coating is produced by depositing, on each preform, successive layers of a silica gel and a polymer glue.

A porous sol-gel film is thus formed around each preform. The thickness of such a film can typically be between 20 and 10,000 nm.

Compared with the “layer-by-layer” method, this coating method has the advantage of being particularly well suited to low diameter preforms, in other words typically less than 50 μm.

Whatever the coating method used, the preforms are assembled into a bundle (before or after implementing the coating), and bonded together by a binder so as to form a monolithic structure.

This binder advantageously comprises a sol of colloid or nanoscopic particles.

For example, once the coated preforms are assembled into a bundle and before ablation of the preforms, the bundle is successively impregnated by a polyelectrolyte solution then by sols of binder so as to construct a thickness of colloidal material filling the interstices between the preforms, in order to create the monolith.

The binder can be, as for the material coating the preforms, a silica or alumina sol or an aluminosilicate. Advantageously, this can be a material that is porous or intended to become porous in the final material. Indeed, it is known that the performance of the packing is promoted with respect to a material transfer operation by enabling the diffusion of species travelling through the packing with respect to the molecules travelling through the channels between the contiguous channels, a phenomenon known as diffusion bridging and necessary for the proper operation of a separation by chromatography in particular. This last diffusion bridging operation is particularly desirable with respect to the molecules of interest, and particularly for the molecule or molecules to be separated by chromatography. The material of the binder can be identical to or different from that of the coating material of the preforms.

Advantageously, the binder of the preforms that are covered “layer-by-layer” is obtained by a sol gel method. This leads to the creation of a gel between the ablative preforms of the bundle, substantially by hydrolysis of an organometallic precursor.

The term “hydrolysis of an organometallic precursor” shall mean the hydrolysis of the organometallic precursor into M-O-M bonds (M designates the metal of the organometallic precursor).

In the case where M is a silicon atom, in particular and in a non-limiting manner, M-O—R, M-N—R, M-S—R, M-O—B bonds, where R is an organic group, of the organometallic precursor are considered to be hydrolysable.

In the case where M is a silicon atom, in particular and in a non-limiting manner, the M-C-bonds are generally considered to be non-hydrolysable. It is noted however that the addition of substituents or heteroatoms, such as O, N, S, etc. on the carbon C can make these M-C bonds fragile. In this latter case, the bonds are considered to be hydrolysable.

Thus, for example, for one mole of tetraalkoxysilane of formula M(OR)₄ with M=Si, OR being the alkoxy radical, R being an alkyl, for example a methyl or ethyl group, the reaction is written as: Si(OR)₄+2 H₂O->SiO₂+4 ROH

Thus, for example, for one mole of trialkoxysilane of formula R′M(OR)₃ with M=Si, OR being the alkoxy radical, R being an alkyl, for example a methyl or ethyl group, R′ being for example an alkyl, for example a methyl or ethyl group, the stoichiometric quantity of water required is 1.5 moles/mole of trialkoxysilane.

Thus for example, for one mole of dialkoxysilane of formula R′R″M (OR)₂ with M=Si, OR being the alkoxy radical, R being an alkyl, for example a methyl or ethyl group, R′ being an alkyl, for example a methyl or ethyl group, R″ being an alkyl, for example a methyl or ethyl group, the stoichiometric quantity of water required is one mole/mole of dialkoxysilane.

R′ and R″ can likewise advantageously be the radicals dodecyl, octadecyl, n-octyl, n-propyl, vinyl, n-butyl, 3-chloropropyl, 3-aminopropyl, 2-aminoethyl-3-aminopropyl, 3-aminopropyl, 3-ureidopropyl, 3-glycidoxypropyl, 3-glycidoxypropyl, 3-methacryloxypropyl, bis(propyl)tetrasulfide, bis(propyl)disulfide, 3-mercaptopropyl, trifluoropropyl, containing epoxy bonds, etc. O—R can advantageously be an alkoxy radical (e.g. methoxy, ethoxy), acyloxy, acetoxy, ketoxime, methylethylketoxime, oximino, etc. (O—R)₄, (O—R)₃, (O—R)₂, can themselves respectively represent 4, 3, or 2 R groups listed above, all identical or different.

The gel can be based on any mineral compound leading to a cohesion of the monolith. Thus, the gel can be a gel based on aluminium oxide, silicon oxide, zirconium oxide, titanium oxide, the oxide of a rare earth such as yttrium, cerium or lanthanum, boron oxide, iron oxide, magnesium oxide, calcium oxide, strontium oxide, barium oxide, germanium oxide, phosphorus oxide, lithium oxide, potassium oxide, sodium oxide, niobium oxide, copper oxide or one of the mixtures thereof. In certain embodiments, the gel is a gel based on silicon oxide (silica gel) or aluminium oxide (alumina gel).

In certain embodiments, the gel is a gel based on zirconium oxide or titanium oxide.

In certain embodiments, the gel is a multi-component oxide gel. For example, the gel can consist of binary oxides of zirconium and yttrium, zirconium and cerium, zirconium and calcium, barium and titanium, lithium and niobium, phosphorus and sodium or boron and lithium. The gel can be a gel consisting of silicate, for example binary silicates based on silica and boron oxide, aluminium oxide, germanium oxide, titanium oxide, zirconium oxide, strontium oxide or iron oxide, ternary silicates, multi-component silicates comprising more than three constituents. In certain embodiments, the gel is a multi-component oxide gel, for example an aluminosilicate gel, for example a clay.

The gel is prepared in situ by the well-known so-called sol-gel (“solution-gelation”) process.

In the context of the present invention, the gel is created between the preforms by hydrolysis of an organometallic precursor. The organometallic precursor comprises at least one, in particular at least two, hydroxyl groups or hydrolysable groups for forming metal oxides during their hydrolysis. Thus, the organometallic precursor is typically an organometallic alkaloid, an organometallic acetate, an organometallic carboxylate, an organometallic halide, an organometallic nitrate, an organometallic alkanoate or an organometallic acyloxide.

Examples of organometallic precursors include, in a non-limiting manner, tetrachlorosilane, aluminium nitrate (which can be hydrolysed in the presence of urea), tetramethoxysilane, tetraethoxysilane, diethyl(dimethoxy)silane and triethyl(methoxy)silane.

The organometallic precursor is preferably an organometallic alkaloid.

The hydrolysis step is generally catalysed by an acid or a base. The choice of an acid or base catalyst typically depends on the precursor or precursors used.

Thus, in other words, the creation of a gel can be advantageously worded in the following manner:
(b1) preparing a hydrolysis product, or sol, comprising an organometallic precursor as described above;
(b2) immersing the ablative preforms of the bundle in the sol;
(c2) hydrolysis of the organometallic precursor.

The gel is dried before after ablation of the preforms. The drying is carried out under conditions making it possible to ensure its structural and mechanical integrity as much as possible, in particular in such a way as to limit as much as possible the formation of fissures and macroscopic or microscopic shrinkage.

The drying can be carried out under vacuum or at atmospheric pressure, preferably at ambient temperature. The drying is typically carried out slowly at a controlled temperature and partial pressure. The drying time is typically at least one hour, or greater than ten hours, greater than 24 hours and can extend to several days. In certain embodiments, the drying time is 48 hours. The larger, in particular the thicker, the material to be dried, the longer will be the drying time. In certain embodiments, the drying is carried out at ambient temperature (20-25° C.) under vacuum at a pressure of 1 to 50 kPa for approximately 48 hours.

In certain embodiments, the drying is carried out after a maturation making it possible to reinforce the structure of the gel and to increase the diameter of its pores. The maturation is typically carried out while keeping the gel at ambient temperature for a period of approximately 24 hours or greater than 24 hours.

According to the present invention, the “layer-by-layer” deposit preferably comprises a silica sol. Advantageously, in this case, an optional binder is obtained by a sol gel method based on silico-organic precursors.

In general, a silica gel typically has a specific surface area ranging from 20 to 1200 m²/g, preferably ranging from 20 to 700 m²/g, more preferably between 70 and 450 m²/g.

Silica gel typically has a pore volume ranging from 20% to 90% by volume of the gel, more advantageously ranging from 40% to 70%, or even 65% by volume of the gel. The term “volume of the gel” means the volume of gel between the conduits of the monolith delimited by its outer contour, separate from any spaces intended to keep open a passage to the fluid by maintaining a space between different masses or portions of silica gel, and outside the volume delimiting the contours of the spacers, i.e. the volume of the gel located between the conduits of the monolith. The optional spacers are not taken into account in determining the volume of the gel; in other words, in the case where spacers are present, the gel is considered to be located outside of the spacers.

Silica gel is generally produced in such a way as to obtain large-diameter pores. It is known that the capillary forces leading to the shrinking and cracking of the gel during its drying vary as the inverse of this diameter. The diameter of the pores of the gel before drying is typically greater than 4 nm, preferably greater than 10 nm and does not generally exceed 1000 nm. The diameter of the pores of the gel after drying is typically greater than 2 nm, preferably greater than 10 nm and does not generally exceed 1000 nm.

In certain embodiments, the precursor sol of the silica gel comprises additives conventionally used for the preparation of packings. Thus, the sol may comprise surfactants or chemical additives to control drying such as formamide. This will reduce cracking during drying.

In certain embodiments, a solid filler can be added to the gel. The solid filler can mechanically reinforce the resulting gel, limit its shrinkage and optionally give the final gel an additional functionality, such as additional specific surface area or a catalytic functionality.

The solid filler can be silica gel powder or alumina gel powder. Advantageously this powder has a high specific surface area, advantageously greater than 250 m²/g, more advantageously greater than 450 m²/g, still more advantageously greater than 700 m²/g. Advantageously this powder has a very fine particle size, less than 25 μm, preferably less than 3 μm, more preferably less than 0.5 μm.

The solid filler can consist of fibres, microfibres or nanofibres, such as “whiskers” such as potassium titanate fibres. These are marketed, in particular, under the brand name TISMO D. They give a greater rigidity to the final material.

The specific surface areas, pore sizes and pore volumes mentioned in this text are measured by nitrogen absorption using the BET (Brunauer, Emmett and Teller) method.

### Ablation of the Preforms

The ablation of the preforms can be performed by any suitable method, such as dissolving, chemical reaction, oxidation, pyrolysis, hydrolysis, vaporisation, depolymerisation, into soluble or volatile monomers, among other methods, or by a combination of these methods, depending on the material of the preforms.

For example, for preforms in the form of polyamide threads, the ablation is advantageously carried out by pyrolysis. For preforms in the form of carbon fibres, the ablation is also advantageously carried out by pyrolysis.

Advantageously, and preferably but not exclusively, the method according to the invention is completed by a sintering operation of the material deposited layer-by-layer and its optional binder. This operation can be carried out at a variable temperature depending on the nature of the material deposited. Advantageously, for a material of the silica sol or silica gel type, this temperature is typically between 500 and 1000° C., and more advantageously between 700 and 900° C.

### Final Treatment of the Monolith

The monolith can receive a final surface treatment, for example by a silane, alcohol, carboxylic acid or any other functionality that is chimisorbed or physisorbed by the material of the monolith. Reference is made to the prior art for performing the surface treatment according to the desired application.

Optionally, a silica gel packing according to the invention can be grafted using a functional silane, in order to modify its absorption and retention properties for a chromatographic application.

The functional silanes that can be used include, in a non-limiting manner, dodecyltrimethoxysilane, octadecyltrimethoxysilane, hexadecyltrimethoxysilane, methyltrimethoxysilane, n-octyltriethoxysilane, n-octyltrimethoxysilane, methyltriacetoxysilane, n-propyltrimethoxysilane, n-propyltriethoxysilane, ethyltriacetoxysilane, vinyltriacetoxysilane, vinyltri(2-methoxyethoxy)silane, 3-chloropropyltriethoxysilane, 3-chloropropylmethyldimethoxysilane, 3-chloropropylmethyldimethoxysilane, 3-aminopropyltriethoxysilane, 2-aminoethyl-3-aminopropyltrimethoxysilane, 3-aminopropyltrimethoxysilane, bis(trimethoxysilypropyl)amine, 3-ureidopropyltrimethoxysilane, 3-glycidoxypropyltrimethoxysilane, 3-glycidoxypropylmethyldimethoxysilane, 3-methacryloxypropyltrimethoxysilane, 3-methacryloxypropylmethyldimethoxysilane, bis(3-triethoxysilylpropyl)tetrasulfide, bis(3-triethoxysilylpropyl)disulfide, 3-mercaptopropyltrimethoxysilane, 3-mercaptopropylmethyldimethoxysilane, vinyltris(methylethylketoxime)silane, vinyl oximo silane, methyltris(methylethylketoxime)silane, methyl oximino silane, tetra(methylethylketoxime)silane, trifluoropropylmethyldimethoxylsilane, silanes containing epoxy bonds, etc.

In certain embodiments, the material obtained, i.e. the gel, is mesoporous and preferably has no macroporosity. The gel differs, in particular, from the multimodal silica gels marketed by Merck under the trade name Chromolith, and derived from the research of K Nakanishi [3], [4], and N. Ishizuka [5].

Such gels are obtained by a standard sol gel method not involving spinodal decomposition.

In certain embodiments, the material obtained, i.e. the gel, is macroporous and involves spinodal decomposition. In particular, it concerns multimodal silica gels of the type marketed by Merck under the trade name Chromolith, and derived from the research of Takanishi and Ishizuka [3], [4], [5] in Japan.

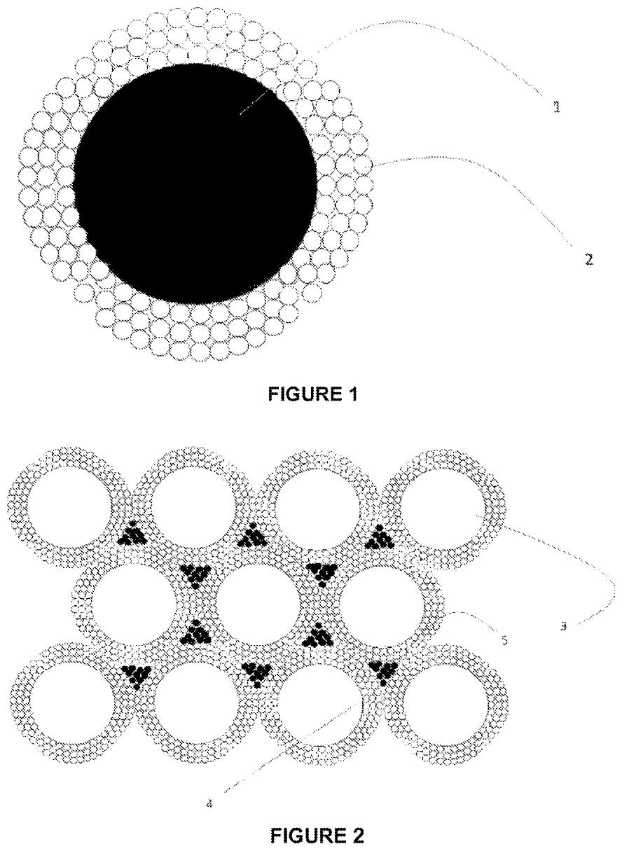

FIG. 1 shows a preform 1 covered, using a “layer-by-layer” method, with three successive layers 2 of colloidal silica particles.

FIG. 2 shows a monolith consisting of a bundle of such successive layers 2 for which each preform 1 has been removed and leaves place for a channel 3. The interstices 4 between the preforms are filled by additional particles 5 that are identical to or different from the particles constituting the layers 2, and in the latter case advantageously inert with respect to the chromatographic separation.

### Example 1

A bundle of carbon fibres containing 12,000 filaments of 7 μm diameter provided by GOODFELLOW is successively treated by baths of aqueous solution at 0.5% by weight poly (diethylaminoethyl methacrylate) with molecular weight 10,000 g, Sigma Aldrich reference 910104, in acetate form, rinsed with demineralised water, then treated with a solution of 10% silica sol with 200 nm size particles, and rinsed again with distilled water. The operation is repeated four times.

A film of porous silica is obtained having 0.5 to 1 μm thickness on the fibres. The assembly is taken to 700° C. for 12 hours in air in order to improve the mechanical strength and remove the carbon fibres by pyrolysis.

### Example 2

The operating conditions of the above example 1 are repeated.

The assembly is treated four times successfully by baths of aqueous solution at 0.5% by weight of poly(diethylaminoethyl methacrylate) of molecular weight 10,000 g Sigma Aldrich reference 910104, in acetate form, rinsed with demineralised water, then treated by a 10% solution of silica sol of particle size 70 nm, and rinsed again with distilled water, and the bundle of carbon fibres is additionally compacted in a U-shaped quartz profile with inner passage of 2 mm×2 mm and 300 mm length, before pyrolysis. The assembly is taken to 700° C. for 12 hours in air in order to improve the mechanical strength and remove the carbon filaments by pyrolysis.

A porous multi-capillary silica monolith suitable for chromatography is thus obtained.

### Example 3

The operating conditions of above example 1 are repeated, and the bundle of fibres is compacted in a U-shaped quartz profile with inner passage of 2 mm×2 mm and 300 mm length before pyrolysis.

The assembly is treated with a 50% silica sol solution with particles of size 22 nm, and drained. The assembly is taken to 700° C. for 12 hours in air in order to improve the mechanical strength and remove the carbon filaments by pyrolysis.

A porous multi-capillary silica monolith suitable for chromatography is thus obtained.

### Example 4

A bundle of carbon fibres containing 12,000 filaments of 7 μm diameter provided by GOODFELLOW is successively treated by baths of aqueous solution at 0.5% by weight poly (diethylaminoethyl methacrylate) with molecular weight 10,000 g, Sigma Aldrich reference 910104, in acetate form, rinsed with demineralised water, then treated with a solution of 10% silica sol with 70 nm size particles, and rinsed again with distilled water. The operation is repeated four times.

In this example, the carbon fibres thus covered are assembled into a bundle, the bundle is immersed in a precursor solution of a silica gel, which solution causes a gel around the fibre, then the fibres are removed by pyrolysis and combustion.

The bundle is produced by assembling these filaments into a bundle of rectangular cross-section, of width 1700 μm, depth 250 μm and length 100 mm. This bundle is created by insertion in such a conduit precisely machined in a sheet of titanium (ASTM grade 2) that is 100 mm×20 mm×10 mm.

The bundle of carbon fibres is impregnated with a mixture of 1.6 g of Brij 56 (commercial surfactant), 1 g dodecane, 4 g tetramethoxysilane, and 2 g of 0.05 N HCl in deionised water. TEOS, dodecane and Brij are mixed at 50° C. until the mixture is homogeneous. The 0.5 N acid (HCl) is then added under vigorous stirring. The mixture is poured into the conduit bearing the fibres.

The packing is closed by a top cover consisting of a flat sheet of titanium (ASTM grade 2) of dimensions identical to those of the base titanium sheet, screwed onto the latter, on which is previously deposited a thickness of approximately 5 micrometres of a paraffin melting at 90° C.

The mixture is left to polymerise and gel for 24 hours at 20° C.

The two ends of the packing are cut flush with the titanium sheet so as to release the section of the packing.

The packing has a length of 100 mm.

The cover is raised and the packing is dried under vacuum.

The resulting product is heated to 700° C. in an air atmosphere in order to convert it into a multi-capillary packing by burning off the carbon fibres.

Once cooled, the packing is re-closed on its upper part by a flat sheet of titanium (ASTM grade 2) of the same dimensions, or cover, screwed on that containing the packing.

### Example 5

A bundle of carbon fibres containing 12,000 filaments of 7 μm diameter provided by GOODFELLOW is successively treated by baths of aqueous solution at 0.5% by weight poly (diethylaminoethyl methacrylate) with molecular weight 10,000 g, Sigma Aldrich reference 910104, in acetate form, rinsed with demineralised water, then treated with a solution of 10% silica sol with 70 nm size particles, and rinsed again with distilled water. The operation is repeated four times.

In this example, the carbon fibres thus covered are assembled into a bundle, the bundle is immersed in a precursor solution of a silica gel, which solution causes a gel around the fibre, then the fibres are removed by pyrolysis and combustion.

The bundle is produced by assembling these filaments into a bundle of rectangular cross-section, of width 1700 μm, depth 250 μm and length 100 mm. This bundle is created by insertion in such a conduit precisely machined in a sheet of titanium (ASTM grade 2) that is 100 mm×20 mm×10 mm.

The bundle of carbon fibres is impregnated with a mixture of 1.6 g of Brij 56 (commercial surfactant), 1 g dodecane, 4 g tetramethoxysilane, and 2 g of 0.05 N HCl in deionised water. TEOS, dodecane and Brij are mixed at 50° C. until the mixture is homogeneous. The 0.5 N acid (HCl) is then added under vigorous stirring. The mixture is poured into the conduit bearing the fibres.

The packing is closed by a top cover consisting of a flat sheet of titanium (ASTM grade 2) of dimensions identical to those of the base titanium sheet, screwed onto the latter, on which is previously deposited a thickness of approximately 5 micrometres of a paraffin melting at 90° C.

The mixture is left to polymerise and gel for 24 hours at 20° C.

The two ends of the packing are cut flush with the titanium sheet so as to release the section of the packing.

The packing has a length of 100 mm.

The cover is raised and the packing is dried under vacuum.

The resulting product is heated to 700° C. in an air atmosphere in order to convert it into a multi-capillary packing by burning off the carbon fibres.

Once cooled, the packing is re-closed on its upper part by a flat sheet of titanium (ASTM grade 2) of the same dimensions, or cover, screwed on that containing the packing.

### Example 6

A bundle of carbon fibres containing 12,000 filaments of 7 μm diameter provided by GOODFELLOW is successively treated by baths of aqueous solution at 0.5% by weight poly (diethylaminoethyl methacrylate), rinsed with demineralised water, then treated with a solution of 10% silica sol with 20 nm size particles, and rinsed again with distilled water. The operation is repeated four times.

In this example, the carbon fibres thus covered are assembled into a bundle, the bundle is immersed in a precursor solution of a macroporous silica gel obtained by spinodal decomposition, which solution causes a gel around the fibre, then the fibres are removed by pyrolysis and combustion.

The bundle is produced by assembling these filaments into a bundle of rectangular cross-section, of width 1700 μm, depth 250 μm and length 100 mm. This bundle is created by insertion in such a conduit precisely machined in a sheet of titanium (ASTM grade 2) that is 100 mm×20 mm×10 mm.

The bundle is produced with a length of 75 mm.

A silicic monolith is synthesised from tetraethoxysilane (TEOS, Aldrich 99%), polyethylene oxide (PEO, molar mass=10,000, Aldrich 99%), nitric acid (68%, Aldrich) and NH₄OH (analytical purity, Aldrich).

A 250 mL Erlenmeyer flask is placed in an ice bath at 0° C. with a magnetic bar. Then, demineralised water (36 g, 2 mol) and nitric acid (68% HNO3, 3.60 g, 38.84 mmol) are added and stirred at 500 rpm for 15 min. Then, PEO (4.79 g PEO including 0.11 mol unit EO) is added and the mixture is stirred for one hour at 700 rpm in order that all the PEO is dissolved. TEOS (37.70 g, 0.18 mol) is then added and the mixture is stirred for one hour. The transparent solution obtained is then poured using a 10 mL pipette in the core of the previously obtained bundle of segments, stored beforehand in a dry environment at 0° C. before filling. The packing is closed by a top cover consisting of a flat sheet of titanium (ASTM grade 2) of dimensions identical to those of the base titanium sheet, screwed onto the latter, on which is previously deposited a thickness of approximately 5 micrometres of a paraffin melting at 90° C.

The bar is then placed in an oven under a saturated atmosphere of water vapour at 40° C. for 72 hours. The titanium cover is removed.

The bar is immersed in a 2 L beaker with 1500 mL of demineralised water at ambient temperature for 1 h. The monolith is then washed four times in the same way, by immersion in the demineralised water (500 mL, 1 h) until a neutral pH is obtained. The monolith is then subjected to a base treatment. It is then immersed in 400 mL of an ammonia solution (0.1 M) in a polypropylene flask (500 mL). The flask is then placed in an oven at 40° C. for 24 hours.

The recovered monolith is rinsed using a wash bottle with distilled water, dried at ambient temperature for 48 h and at 40° C. for 24 h on a flat surface.

It is calcined at 650° C. under air for 24 hours (ramp 1° C. min-1).

A flat cover is prepared in a 20×10×75 mm sheet of titanium (FIGS. 19 and 20).

The cover is repositioned with a PEEK seal at 340° C. and cooled.

### Example 7

A bundle of carbon fibres containing 12,000 filaments of 7 μm diameter provided by GOODFELLOW is successively treated by baths of aqueous solution at 0.5% by weight poly(diethylaminoethyl methacrylate) with molecular weight 10,000 g, Sigma Aldrich reference 910104, in acetate form, rinsed with demineralised water, then treated with a solution of 10% porous silica gel nanoparticles of pore size 4 nm and with porous volume greater than 50% by volume, marketed by Sigma Aldrich under reference 748161 with particle size 200 nm, and rinsed again with distilled water. The operation is repeated four times.

In this example, the carbon fibres thus covered are assembled into a bundle, the bundle is immersed in a precursor solution of a silica gel, which solution causes a gel around the fibre, then the fibres are removed by pyrolysis and combustion.

The bundle is produced by assembling these filaments into a bundle of rectangular cross-section, of width 1700 μm, depth 250 μm and length 100 mm. This bundle is created by insertion in such a conduit precisely machined in a sheet of titanium (ASTM grade 2) that is 100 mm×20 mm×10 mm.

The bundle of carbon fibres is impregnated with a mixture of 1.6 g of Brij 56 (commercial surfactant), 1 g dodecane, 4 g tetramethoxysilane, and 2 g of 0.05 N HCl in deionised water. TEOS, dodecane and Brij are mixed at 50° C. until the mixture is homogeneous. The 0.5 N acid (HCl) is then added under vigorous stirring. The mixture is poured into the conduit bearing the fibres.

The packing is closed by a top cover consisting of a flat sheet of titanium (ASTM grade 2) of dimensions identical to those of the base titanium sheet, screwed onto the latter, on which is previously deposited a thickness of approximately 5 micrometres of a paraffin melting at 90° C.

The mixture is left to polymerise and gel for 24 hours at 20° C.

The two ends of the packing are cut flush with the titanium sheet so as to release the section of the packing.

The packing has a length of 100 mm.

The cover is raised and the packing is dried under vacuum.

The resulting product is heated to 700° C. in an air atmosphere in order to convert it into a multi-capillary packing by burning off the carbon fibres.

Once cooled, the packing is re-closed on its upper part by a flat sheet of titanium (ASTM grade 2) of the same dimensions, or cover, screwed on that containing the packing.

### REFERENCES

[1] Core-shell particles, preparation, fundamentals and application in high performance liquid chromatography; R. Hayes, A. Ahmed, T. Edge, H. Zhang, Journal of Chromatography A, 1357, (2014), 36-52
[2] U.S. Pat. No. 3,505,785
[3] K Nakanishi, Phase separation in silica sol-gel system containing polyacrylic acid, Journal of non-crystalline Solids 139 (1992), 1-13 and 14-24;
[4] K. Nakanishi, Phase separation in Gelling Silica-Organic Polymer Solution: Systems Containing Poly(sodium styrenesulfonate), J. Am. Ceram. Soc. 74 (10) 2518-2530-30 (1991);
[5] N. Ishizuka, Designing monolithic double pore silica for high-speed liquid chromatography, Journal of Chromatography A, 797 (1998), 133-137.

1. A method for producing a multi-capillary packing comprising a plurality of channels suitable for convection of a fluid between an inlet face and an outlet face of said packing, said method comprising:
providing a plurality of preforms suitable for forming, after ablation, a respective capillary channel of the packing;
assembling said plurality of preforms into a bundle;
coating each preform with a plurality of porous layers by depositing alternating layers of a polyelectrolyte and nanoparticles or colloidal nanoparticles,
bonding the plurality of coated preforms to form a porous monolith; and
ablating the plurality of preforms to form the channels in said porous monolith.

2. The method according to claim 1, wherein at least one dimension from a length, width, thickness or diameter of the nanoparticles or colloidal nanoparticles is less than 1 μm.

3. The method according to one of claim 1, wherein the polyelectrolyte is chosen from polydiallylmethylammonium chloride, poly(diethylaminoethyl methacrylate)acetate, poly-8-methacrylyloxyethyldiethylmethyl ammonium methyl sulfate (poly-g-MEMAMS), or polymethacrylic acid

4. The method according to claim 1, wherein the nanoparticles comprise a silica sol, an activated alumina sol or an aluminosilicate, such as a zeolite.

5. The method according to claim 1, wherein bonding the plurality of coated preforms is carried out by sintering.

6. The method according to claim 1, wherein bonding the plurality of coated preforms is carried out by addition of a binder between said preforms.

7. The method according to claim 6, wherein the binder is obtained by a sol gel method.

8. The method according to claim 6, wherein the binder is obtained by drying a sol.

9. The method according to claim 6, wherein the binder comprises a silica gel.

10. The method according to claim 1, wherein ablating the plurality of preforms comprises at least one of following techniques: dissolving, chemical reaction, oxidation, pyrolysis, hydrolysis, vaporization, and depolymerization.

11. The method according to claim 1, wherein the each preform has a diameter less than 10 μm, or, when the plurality of preforms have a non-circular cross-section, the diameter of a preform of circular cross-section having an identical area is less than 10 μm.

12. The method according to claim 1, wherein the plurality of preforms comprise polyamide fibers.

13. The method according to claim 1, wherein the plurality of preforms comprise carbon fibers.

14. The method according to claim 2, wherein the nanoparticles or colloidal nanoparticles have at least one dimension from the width, length, thickness or diameter, which is less than 0.2 μm.

15. The method according to claim 1, wherein the nanoparticles or colloidal nanoparticles are porous.

16. The method according to claim 15, wherein the polyelectrolyte has a molecular weight suitable for preventing the penetration of said polyelectrolyte into pores of said nanoparticles.

17. A method for producing a multi-capillary packing comprising a plurality of channels suitable for convection of a fluid between an inlet face and an outlet face of said packing, said method comprising:
providing a plurality of preforms suitable for forming, after ablation, a respective capillary channel of the packing;
assembling said plurality of preforms into a bundle;
coating each preform with a plurality of porous layers by depositing alternating layers of nanoparticles and a polymer glue;
bonding the plurality of coated preforms to form a porous monolith; and
ablating the plurality of preforms to form the channels in said porous monolith.

18. The method according to claim 17, wherein at least one dimension from a length, width, thickness or diameter of the nanoparticles is less than 1 μm.

19. The method according to claim 17, wherein the nanoparticles comprise a silica sol, an activated alumina sol or an aluminosilicate.

20. The method according to claim 17, wherein bonding the coated preforms is carried out by sintering.

21. The method according to claim 17, wherein bonding the coated preforms is carried out by addition of a binder between said preforms.

22. The method according to claim 21, wherein the binder is obtained by a sol gel method.

23. The method according to claim 21, wherein the binder is obtained by drying a sol.

24. The method according to claim 21, wherein the binder comprises a silica gel.

25. The method according to claim 17, wherein ablating the plurality of preforms comprises at least one of following techniques: dissolving, chemical reaction, oxidation, pyrolysis, hydrolysis, vaporization, and depolymerization.

26. The method according to claim 17, wherein each preform has a diameter less than 10 μm or, when the plurality of preforms have a non-circular cross-section, the diameter of a preform of circular cross-section having an identical area is less than 10 μm.

27. The method according to claim 17, wherein the plurality of preforms comprise polyamide fibers.

28. The method according to claim 17, wherein the plurality of preforms comprise carbon fibers.

29. The method according to claim 18, wherein the nanoparticles have at least one dimension from the width, length, thickness or diameter, which is less than 0.2 μm.

30. The method according to claim 17, wherein the nanoparticles are porous.

31. The method according to claim 30, wherein the polymer glue has a molecular weight suitable for preventing penetration of said polymer glue into pores of said nanoparticles.
